(19) United States
(12) Patent Application Publication
(10) Pub. No.: US 2018/0371289 A1
(43) Pub. Date: Dec. 27, 2018

(54) FUNCTIONALIZED POLYURETHANES POLYMERS AND FILM ARTICLES

(71) Applicant: 3M INNOVATIVE PROPERTIES COMPANY, St. Paul, MN (US)

(72) Inventors: Yu Yang, Eden Prairie, MN (US); Jiyoung Park, Woodbury, MN (US); Suresh S. Iyer, Woodbury, MN (US); Timothy D. Fletcher, Lino Lakes, MN (US); Thomas E. S. Muehle, Woodbury, MN (US); Jeffrey A. Peterson, Hugo, MN (US); Thomas J. Blong, Woodbury, MN (US)

(21) Appl. No.: 15/777,728

(22) PCT Filed: Nov. 30, 2016
(86) PCT No.: PCT/US2016/064220

§ 371 Date: May 21, 2018

Related U.S. Application Data
(60) Provisional application No. 62/265,059, filed on Dec. 9, 2015.

(51) Int. Cl. C09D 175/06; C08G 18/42; C08G 18/10; C08G 18/32; C08G 18/75; C08G 18/24; C08G 18/08; C09D 5/00; C08J 7/04

(52) U.S. Cl. CPC C09D 175/06; C08G 18/4213; C08G 18/10; C08G 18/3215; C08G 18/751; C08J 2427/20; C08G 18/0809; C09D 5/002; C08J 7/042; C08J 2367/02; C08J 2475/06; C08G 18/246

(57) ABSTRACT

Polyurethane polymers are described comprising polymerized units comprising a hydroxy functional aromatic group wherein the hydroxy group has been functionalized with an adhesion promoting group. In some embodiments, the polyurethane polymer comprises polymerized units have the general structure wherein L₁ and L₂ are independently divalent linking groups comprising an urethane group; and R_{A} is an adhesion promoting group bonded to the oxygen atom by means of an ionic or covalent bond. In other embodiments, film articles, laminates are described and methods of making functionalized polyurethane polymers are described.

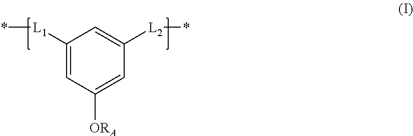

### SUMMARY

In one embodiment a polyurethane polymer is described comprising polymerized units comprising a hydroxy functional aromatic group wherein the hydroxy group has been functionalized with an adhesion promoting group.

In some embodiments, the polyurethane polymer comprises polymerized units have the general structure

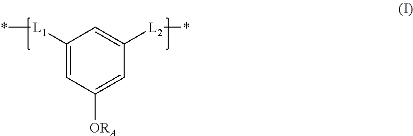

wherein L₁ and L₂ are independently divalent linking groups comprising a urethane group; and
R_{A} is an adhesion promoting group bonded to the oxygen atom by means of an ionic or covalent bond.

In other embodiments, film articles and laminates are described.

In other embodiments, methods of making functionalized polyurethane polymers are described.

In one embodiment, the method of making the polyurethane polymer comprises providing a polyurethane polymer intermediate comprising polymerized units of a hydroxy-functional aromatic group; reacting the hydroxy-functional aromatic group with a functionalization compound having the formula R_{OH}—R_{A}, wherein R_{OH} is a hydroxy-reactive group and R_{A} is an adhesion-promoting group.

In one embodiment, the method of making the polyurethane polymer comprises reacting at least one polymeric polyol with a diisocyanate compound; reacting the isocyanate terminal groups with an aromatic compound comprising at least three hydroxy groups thereby; and reacting a hydroxy group of the aromatic compound with a functionalization compound having the formula R_{OH}—R_{A}, wherein R_{OH} is an hydroxy-reactive group and R_{A} is an adhesion-promoting group

### DETAILED DESCRIPTION

In one embodiment a polyurethane polymer is described. The polyurethane polymer comprises polymerized units comprising a hydroxy functional aromatic group wherein the hydroxy group has been functionalized with an adhesion promoting group.

The polyurethane polymer is generally prepared by the reaction of conventional (e.g. polymeric) polyols and polyisocyanates (e.g. diisocyanate), and at least one aromatic polyol (e.g. triol) comprising a hydroxy-functional aromatic group. The hydroxy-functional aromatic group is reacted with a functionalization compound. Although the polyurethane compositions are generally formed from difunctional components (e.g. diols, diisocyanates, etc.), multifunctional components with functionality greater than two may be incorporated into the polyurethane in limited amounts.

In one embodiment, the method of making the polyurethane polymer described herein generally comprises providing a polyurethane polymer comprising polymerized units comprising a hydroxy-functional aromatic group. The hydroxy substituent is typically covalently bonded to an aromatic ring. The hydroxy-functional polyurethane polymer can be characterized as a polyurethane polymer intermediate. The method further comprises reacting the hydroxy substituent of the aromatic group (e.g. aromatic ring) with a functionalization compound having the formula R_{OH}—R_{A} wherein R_{OH} is a hydroxy-reactive group and R is an adhesion-promoting group, as will subsequently be described.

Isocyanate-reactive components such as polyols (e.g. diols), thiols, and amines that may be reacted with diisocyanates to prepare the polyurethane polymer intermediate can be divided into two groups, i.e., high molecular weight compounds and low molecular weight compounds. High molecular weight compounds have a molecular weight of at least 400, 500, 600, 700, 800, or 1000 g/mole to about 10,000 g/mole. In some embodiments, the high molecular weight compounds have a molecular weight no greater than 9,000; 8,000; 7,000; 6,000, or 5,000 g/mole. The low molecular weight compounds (chain extenders) have a molecular weight below 400, 350, 300, or 250 g/mole. The molecular weights are number average molecular weights (Mn) and are determined by end group analysis (OH number). Examples of the high molecular weight compounds are polyester polyols, polyether polyols, and polycarbonates polyols.

Suitable polyester polyols include reaction products of polyhydric, preferably dihydric alcohols. Instead of these polycarboxylic acids, the corresponding carboxylic acid anhydrides or polycarboxylic acid esters of lower alcohols or mixtures thereof may be used for preparing the polyester polyols. The polycarboxylic acids may be aliphatic, cycloaliphatic, aromatic and/or heterocyclic and may be substituted, e.g. by halogen atoms, and/or contain ethylenic unsaturation. The following are mentioned as examples: succinic acid; adipic acid; suberic acid; azelaic acid; sebacic acid; phthalic acid; isophthalic acid; trimellitic acid; phthalic acid anhydride; tetrahydrophthalic acid anhydride; hexahydrophthalic acid anhydride; tetrachlorophthalic acid anhydride, endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate.

Suitable polyhydric alcohols that can be used in the preparation of polyester polyols and that can also useful as low molecular weight polyol chain extenders include, e.g. ethylene glycol; diethylene glycol; (1,2 or 1,3) propylene diol; (1,4 or 1,3) butane diol; (1,6) hexanediol; (1,8) octanediol; neopentyl glycol; (1,4) cyclohexanedimethanol; bis(2-hydroxyethyl) hydroquinone (HQEE); 2-methyl-1,3-propanediol; 2,2,4-trimethyl-1,3-pentanediol; triethylene glycol; tetraethylene glycol; polyethylene glycol; polypropylene glycol; dipropylene glycol; dibutylene glycol; polybutylene glycol, glycerine and trimethlyolpropane. Various mixtures of low molecular weight polyol chain extenders can be utilized.

In some embodiments, the polyhydric alcohol is an adduct of bisphenol A with ethylene oxide or an adduct of bisphenol A with propylene oxide and polyether glycol such as polyethylene glycol, polypropylene glycol and polytetramethylene glycol.

Polyester polyols can be preferred when the polyurethane is utilized as a primer for a polyester substrate.

Various polyester polyols are commercially available including polyester polyols available from Kuraray such as the trade designations KURARAY POLYOL P-520, KURARAY POLYOL P-1020, KURARAY POLYOL P-510, KURARAY POLYOL P-1010, KURARAY POLYOL P-2010, KURARAY POLYOL P-3010, KURARAY POLYOL P-4010, KURARAY POLYOL P-5010, KURARAY POLYOL P-6010, KURARAY POLYOL F-510, KURARAY POLYOL F-1010, KURARAY POLYOL F-2010, KURARAY POLYOL F-3010, KURARAY POLYOL P-2011, KURARAY POLYOL P-2013, KURARAY POLYOL P-520, KURARAY POLYOL P-1020, KURARAY POLYOL P-2020, KURARAY POLYOL P-1012, KURARAY POLYOL P-2012, KURARAY POLYOL P-530, KURARAY POLYOL P-2030, KURARAY POLYOL P-2050, KURARAY POLYOL N-2010, and KURARAY POLYOL PMNA-2016.

Polycarbonates polyols include those obtained from the reaction of diols such as propanediol-(1,3), butanediol-(1,4) and/or hexanediol-(1,6), diethylene glycol, triethylene glycol or tetraethylene glycol with phosgene, diaryl-carbonates such as diphenylcarbonate or with cyclic carbonates such as ethylene or propylene carbonate.

Polycarbonate polyols can be preferred when the polyurethane is utilized as a primer for a polycarbonate substrate. Various polycarbonate polyols are commercially available including polycarbonate polyols available from Kuraray such as the trade designations KURARAY POLYOL C-590, KURARAY POLYOL C-1090, KURARAY POLYOL C-2090, KURARAY POLYOL C-590, KURARAY POLYOL C-1050, KURARAY POLYOL C-1090, KURARAY POLYOL C-2050, KURARAY POLYOL C-2090, and KURARAY POLYOL C-3090.

Suitable polyether polyols are obtained in known manner by the reaction of starting compounds that contain reactive hydrogen atoms with alkylene oxides such as propylene oxide, butylene oxide, styrene oxide, tetrahydrofuran, epichlorohydrin or mixtures of these alkylene oxides. Suitable starting compounds containing reactive hydrogen atoms include the polyhydric alcohols set forth for preparing the polyester polyols and, in addition, water, methanol, ethanol, 1,2,6-hexane triol, 1,2,4-butane triol, trimethylol ethane, pentaerythritol, mannitol, sorbitol, methyl glycoside, sucrose, phenol, isononyl phenol, resorcinol, hydroquinone, 1,1,1- or 1,1,2-tris-(hydroxylphenyl)-ethane.

Various polyether polyols are commercially available including VORANOL™ polyether polyols such as VORANOL™ 4240, VORANOL™ 4701, VORANOL™ 4703, VORANOL™ 5815, VORANOL™ CP1421, and VORANOL™ CP 3131

In one typical synthesis, a high molecular weight (e.g. polyester, polycarbonate, or polyether) polyol is reacted with sufficient polyisocyanate component such that the polyol is chain extended, terminating with an isocyanate functional group.

The polyisocyanate component typically comprises a compound having two isocyanate groups (i.e., diisocyanates and/or adducts thereof). Adducts of the polyisocyanate compounds as defined herein refer to isocyanate functional derivatives of polyisocyanate compounds and polyisocyanate prepolymers. Examples of adducts include but are not limited to those selected from the group consisting of ureas, biurets, allophanates, dimers and trimers of isocyanate compounds, uretonimediones, and mixtures thereof. Any suitable organic polyisocyanate, such as an aliphatic, cycloaliphatic, araliphatic or aromatic polyisocyanate, may be used either singly or in mixtures of two or more.

Aromatic polyisocyanates can be more economical and reactive toward polyols and other poly(active hydrogen) compounds than aliphatic polyisocyanates. Suitable aromatic polyisocyanates include but are not limited to those selected from the group consisting of 2,4-toluene diisocyanate, 2,6-toluene diisocyanate, a dimer of toluene diisocyanate (available under the trademark Desmodur™ TT from Bayer), diphenylmethane 4,4′-diisocyanate (MDI), 1,5-diisocyanato-naphthalene, 1,4-phenylene diisocyanate, 1,3-phenylene diisocyanate, and mixtures thereof. Aliphatic isocyanates can provide better light stability than the aromatic compounds. Examples of useful cycloaliphatic polyisocyanates include but are not limited to those selected from the group consisting of dicyclohexylmethane diisocyanate (H12 MDI, commercially available as DESMODUR™ W from Bayer), isophorone diisocyanate (IPDI), 1,4-cyclohexane diisocyanate (CHDI), 1,4-cyclohexanebis(methylene isocyanate) (BDI), 1,3-bis(isocyanatomethyl)cyclohexane (H6 XDI), and mixtures thereof. Examples of useful linear or branched aliphatic polyisocyanates include but are not limited to those selected from the group consisting of hexamethylene 1,6-diisocyanate (HDI), 1,12-dodecane diisocyanate, 2,2,4-trimethyl-hexamethylene diisocyanate (TMDI), 2,4,4-trimethyl-hexamethylene diisocyanate (TMDI), 2-methyl-1,5-pentamethylene diisocyanate, dimer diisocyanate, the urea of hexamethyl diisocyanate, and mixtures thereof.

In some embodiments the diisocyanate component comprises cyclic aliphatic moieties, such as dicyclohexylmethane moieties, as can be derived from dicyclohexylmethane 4,4′-diisocyanate (H12MDI), and derivatives thereof. Other cyclic aliphatic moieties include alkyl cyclohexy, as can be derived from IPDI. Mixtures of cycloaliphatic moieties can be present.

The polyurethane prepolymer can be characterized as an isocyanate terminated polyurethane prepolymer. The isocyanate groups of the isocyanate terminated polyurethane prepolymer are utilized in subsequent reactions.

The polyurethane prepolymer compositions are typically prepared with a catalyst as known in the art. The amount of catalyst can range up to about 0.5 parts by weight of the isocyanate-terminated prepolymer. In some embodiments, the amount of catalyst ranges from about 0.005 to about 0.05 part by weight. Examples of useful catalysts include but are not limited to those selected from the group consisting of tin II and IV salts such as stannous octoate and dibutyltin dilaurate, and dibutyltin diacetate; tertiary amine compounds such as triethyl amine and bis(dimethylaminoethyl) ether, morpholine compounds such as .beta.,beta.′-dimorpholinodiethyl ether, bismuth carboxylates, zinc-bismuth carboxylates, iron (III) chloride, potassium octoate, and potassium acetate.

Solvents can be utilized to control the viscosity of the isocyanate-terminated prepolymer. Examples of useful solvents (which are typically volatile organic compounds) added for this purpose include but are not limited ketones (e.g. methyl ethyl ketone, acetone), tertiary alcohols, ethers, esters, amides, hydrocarbons, chlorohydrocarbons, chlorocarbons, and mixtures thereof. Such solvent are usually stripped at the end of the reaction by vacuum heating. Under laboratory conditions, a Haake Rotoevaporator or other similar equipment can be used to remove the solvent.

The isocyanate terminated polyurethane prepolymer is reacted with a hydroxy functional aromatic compound comprising at least three hydroxyl groups. Two of the three hydroxyl groups generally react with isocyanate groups of the prepolymer incorporating the hydroxy functional aromatic compound into the backbone of the polyurethane polymer, whereas the third hydroxyl group is generally pendent and remain unreacted such that it can be subsequently reacted with a functionalization compound.

Suitable examples hydroxy functional aromatic compounds include for example benzene triol compounds and aromatic compound comprising at least one hydroxyl group, one or more (e.g. C₁-C₄) alkoxy substituents, and optionally at least one (e.g. C₁-C₄) alkyl substituents such as 2,6-bis(hydroxylmethyl)-p-cresol depicted as follows:

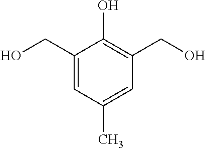

In another embodiment, a hydroxy-functional aromatic ester diol can be utilized as in the polymerization of the polyurethane polymer.

In another embodiments, the compound utilized in the synthesis of the polyurethane that provides the hydroxy-functional aromatic group is a hydroxy-functional aromatic ester diol. For example, an aromatic dicarboxylic acid or ester thereof comprising a hydroxy substituent (e.g. 5-hydroxyisophthalic acid or dimethyl 5-hydroxyisophthate (A)) and a glycol such as ethylene diol (B) can be reacted to form a hydroxy-functional aromatic ester diol as depicted in the following reaction schemes:

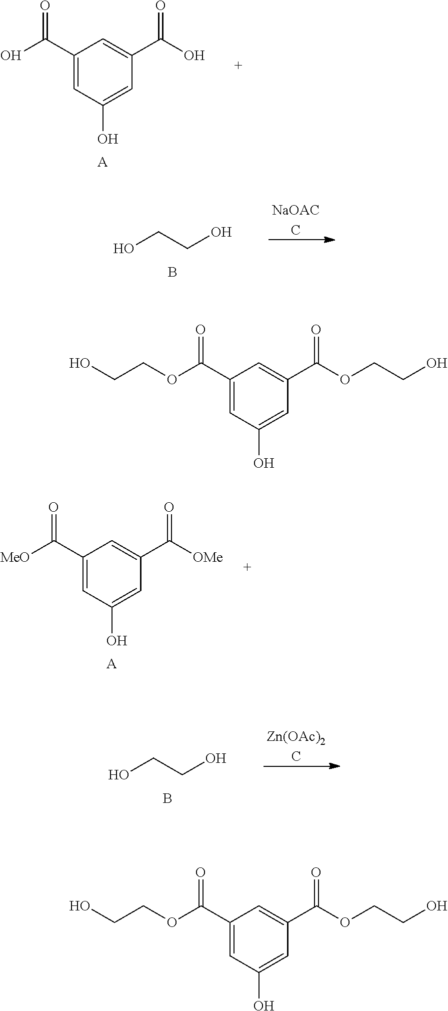

In another embodiments, the compound utilized in the synthesis of the polyurethane that provides the hydroxy-functional aromatic group is a hydroxy-functional aromatic amide diol. For example, an aromatic carboxylic acid ester comprising a hydroxy substituent (e.g. dimethyl 5-hydroxyisophthate (A)) and a hydroxy functional amine such as ethanolamine (B) can be reacted to form a hydroxy-functional aromatic amide diol (C). One illustrative reaction scheme is as follows:

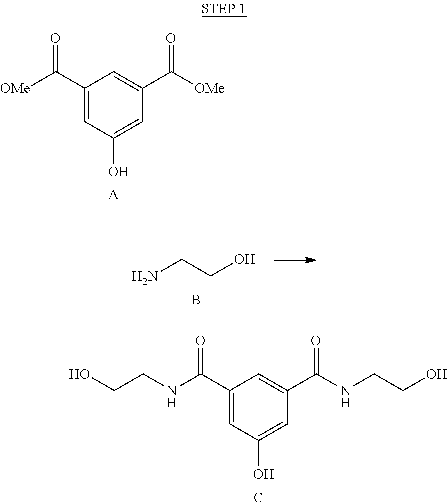

In some embodiments, the polyurethane polymer comprises 50 to 70 wt.-% of polymerized units of (e.g. polyester) polyol, 20 to 40 wt-% of polymerized units of isocyanate, and 5 to 20 wt-% of polymerized units comprising a hydroxy substituted aromatic group. Such concentration can vary depending on the selected of polyol(s) and isocyanate(s).

In typical reaction schemes, the hydroxy substituent of the aromatic group of the polyurethane polymer intermediate is reacted with a functionalization compound having the formula R_{OH}—R_{A} wherein R_{OH} is a hydroxy-reactive group and R_{A} is an adhesion-promoting group. In typical embodiments, a single functionalization compound is utilized. However, a combination of two or more functionalization compounds can also be used.

In some embodiments, the functionalized polyurethane polymer comprises polymerized units having the general structure

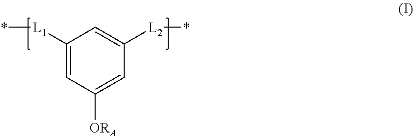

wherein L₁ and L₂ are independently divalent linking groups comprising a urethane group; and R_{A} is an adhesion promoting group bonded to the oxygen atom by means of an ionic or covalent bond. In some embodiments, L₁ and L₂ are independently divalent linking groups comprising an amide and an ester group.

Regardless of the manner of synthesis, the polyurethane polymer comprises a sufficient concentration of polymerized units comprising the adhesion promoting group to achieve the desired properties. The polyurethane polymer typically comprises at least 0.1, 0.5, 1, 1.5, 2, or 2.5 wt.-% of polymerized units comprising the adhesion promoting group. In some embodiments, the polyurethane polymer typically comprises at least 5, 10, 15, 20, 25 or 30 wt.-% of polymerized units comprising the adhesion promoting group. In some embodiments, the polyurethane polymer typically comprises no greater than 60, 55, 50, or 45 wt.-% of polymerized units comprising the adhesion promoting group. In some embodiments, the polyurethane polymer intermediate typically comprises no greater than 10, 9, 8, 7, 6, or 5 wt.-% of polymerized units comprising the adhesion promoting.

In typical embodiments, substantially all the hydroxyl groups of the polyurethane polymer intermediate are converted to an adhesion promoting group. Thus, the hydroxy content of the functionalized polyurethane polymer is typically no greater than 2, 1, 1.5, 1, 0.5, 0.1, 0.005, or 0.0001 wt-% of the functionalized polyurethane polymer.

Various functionalization compounds can be utilized depending on the intended use of the polyurethane polymer. In some embodiments, the polyurethane polymer is utilized as a primer and the functionalization compound is chosen based on the type of material (e.g. substrate) the polyurethane polymer will subsequently be bonded. In other embodiments, the polyurethane polymer is a film and the functionalization compound is chosen based on the type of material that may be disposed upon the film.

In some embodiments, the functionalization compound is a strong base. Strong organic bases include for example amines, N-heterocyclic compounds, tetraalkylammonium and phosphonium hydroxides, metal alkoxides and amides. Some illustrative examples of strong organic bases are terta-n-butyl phosphonium hydroxide and amines, such as 1,8-diazabicyclo[5.4.0]undec-7-ene (DBU), 1,5-Diazabicyclo[4.3.0]non-5-ene (DBN), triethyl amine, N-ethyldiisopropylamine, piperidine, diethyl amine, 4-(dimethylamino)pyridine, 1,4-diazabicyclo[2.2.2]octane (DABCO™), and tetramethyl ammonium hydroxide. Inorganic bases such as metal hydroxide, metal carbonate and the like can also be utilized as the functionalization compound.

Upon reacting the strong base with the hydroxyl group of the hydroxyl functional aromatic group, a salt is formed wherein the resulting adhesion promoting group is typically a cation of the salt of a strong base. In some embodiments, the adhesion promoting group is a N-heterocyclic cation or an organoammonium cation.

In other embodiments, the functionalization compound is an aziridine compound. that comprises at one aziridine group. In some embodiments, the aziridine compound may comprise 2, 3, 4, 5, 6, or greater than 6 aziridine groups.

As depicted in the following reaction scheme, when the aziridine compound comprises a single aziridine group such as 2-methylaziridine, upon reacting with the hydroxy-substituted aromatic group of the polyurethane, the adhesion promoting group comprises an amine.

When the aziridine compound comprises more than one aziridine group, upon reacting with the hydroxyl-substituted aromatic group, the adhesion promoting group comprises one or more aziridine groups.

The aziridine compound may be represented by the following structure:

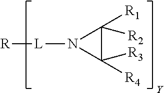

wherein with respect to this aziridine compound
R is a core moiety having a valency of Y;
L is a bond, divalent atom, or divalent linking group;
R₁, R₂, R₃, and R₄ are independently hydrogen or a C₁-C₄ alkyl (e.g. methyl); and
Y is typically 2, 3, or greater.

In some embodiments, R is —SO₂—. In some embodiments, R-L is a residue of a multi(meth)acrylate compound. In some embodiments L is a C₁-C₄ alkylene, optionally substituted with one or more (e.g. contiguous or pendant) oxygen atoms thereby forming ether or ester linkages. In typical embodiments, R₁ is methyl and R₂, R₃, and R₄ are hydrogen.

Representative aziridine compounds include trimethylolpropane tri-[beta-(N-aziridinyl)-propionate, 2,2-bishydroxymethyl butanoltris[3-(1-aziridine) propionate]; 1-(aziridin-2-yl)-2-oxabut-3-ene; and 4-(aziridin-2-yl)-but-1-ene; and 5-(aziridin-2-yl)-pent-1-ene.

In some embodiments, a polyaziridine compound can be prepared by reacting divinyl sulfone with alkylene (e.g. ethylene) imine, such as described in U.S. Pat. No. 3,235,544. On representative compound is di(2-propyleniminoethyl)sulfone, as depicted as follows:

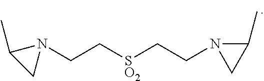

Polyaziridine compounds can be prepared via a Michael addition of a multi(meth)acrylate compound with an (e.g. C₁-C₄ alkyl) aziridine, such as 2-methyl aziridine (also known as 2-methyl ethylenimine). Suitable multi(meth)acrylate compounds comprise at least two and is some embodiments at least 3, 4, 5, or 6 (meth)acrylate functional groups. Representative multi(meth)acrylate compounds typically comprise at least two (meth)acrylate groups including for example hexanediol acrylate (HDDA), pentaerythritol tri(meth)acrylate, pentaerythritol tetra(meth)acrylate, trimethylolpropane tri(methacrylate), dipentaerythritol penta(meth)acrylate, dipentaerythritol hexa(meth)acrylate (“SR444”), trimethylolpropane ethoxylate tri(meth)acrylate, glyceryl tri(meth)acrylate, pentaerythritol propoxylate tri(meth)acrylate, and di(trimethylolpropane) tetra(meth)acrylate. In such reactions each (meth)acrylate group provides a site for addition of the aziridine group and the remaining multi(meth)acrylate starting compound. Thus, R-L is a residue (i.e. recognizable part) of the multi(meth)acrylate compound. Some representative polyaziridine compounds that can be prepared via a Michael addition are as follows:

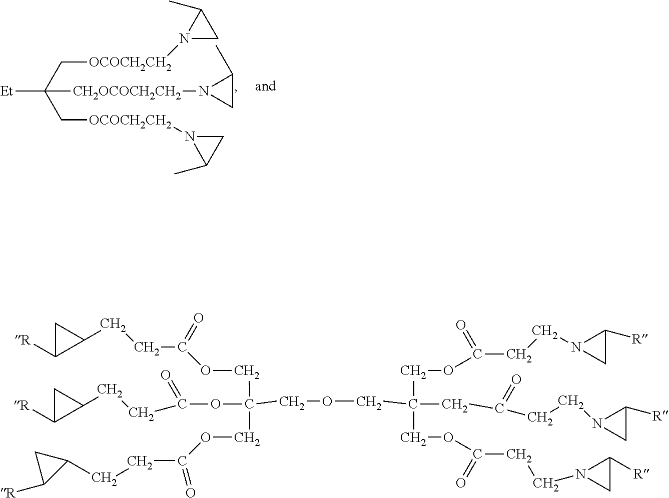

In some embodiments, the polyaziridine compound lacks hydrolyzable (e.g. linking) groups, such as linking groups comprising an ester group. One representative compound, in which the synthesis is described in the forthcoming examples, is as follows:

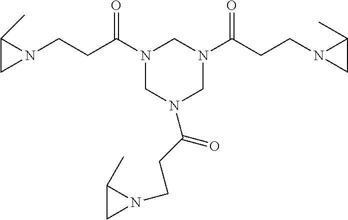 [SMILES: CC1CN1CCC(=O)N1CN(C(=O)CCN2CC2C)CN(C(=O)CCN2CC2C)C1]

In some embodiments the polyaziridine compound may comprise alkylene oxide repeat units, such as ethylene oxide repeat units. The number of alkylene oxide (e.g. ethylene oxide) repeats units is typically at least 2 or 3 and typically no greater than about 20. In some embodiments, the number of alkylene oxide (e.g. ethylene oxide) repeat units averages about 6, 7, 8, or 9. One representative of this type is as follows.

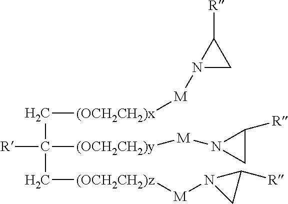

wherein with respect to this aziridine compound
R′ is hydrogen or a C₁-C₄ alkyl;
R″ is hydrogen or a C₁-C₄ alkyl (e.g. methyl);
x, y, and z are independently at least 1; and
M is a bond, divalent atom, or divalent linking group.

In some embodiments, the sum of x+y+z is at least 3, 4, 5, or 6. Further the sum of x+y+z is typically no greater than 20. In some embodiments, M is a covalent bond or a C₁-C₄ alkylene.

Other polyaziridine compounds comprising alkylene oxide repeat units are described in U.S. Pat. No. 8,017,666; incorporated herein by reference.

In other embodiments, the aziridine compound is an aziridine alkoxy silane compound, also referred to as aziridinyl siloxanes. Such compounds are known for examples from U.S. Pat. No. 3,243,429; incorporated herein by reference. Aziridine alkoxy silane compounds may have the general structure:

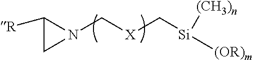

wherein with respect to this aziridine compound
X is a bond, a divalent atom, or a divalent linking group;
R″ and Rare independently hydrogen or a C₁-C₄ alkyl (e.g. methyl);
n is 0, 1 or 2;
m is 1, 2, or 3; and
and the sum or n+m is 3.

One representative compound is 3-(2-methylaziridinyl) ethylcarboxylpropyltriethoxysilane.

In some embodiments, the functionalization compound is an organosilane compound. The organosilane compound comprises at least one hydroxy-reactive group such as epoxy, amine, or halogen (e.g. Cl) and an alkoxysilane group.

Suitable alkoxy silanes typically have the following chemical formula:

(R¹O)ₘ—Si—[R₅—Y]₄₋ₘ

wherein R¹ is independently C₁-C₄ alkyl;
R₅ is alkylene, arylene, or alkarylene;
Y is a hydroxy-reactive group; and
m ranges from 1 to 3, and is typically 2 or 3.

In some embodiments, R₅ is (CH₂)ₙ wherein n ranges from 0 to 12, or n ranges from 0 to 3, or n is 2 or 3. In some embodiments, R¹ methyl or ethyl;

Illustrative compounds include for example 3-chloropropyltrimethoxysilane, 3-chloropropyltriethoxysilane, p-chloromethylphenyltrimethoxysilane, 3-glycidoxypropyl trimethoxysilane, 3-glycidoxypropyl triethoxysilane, 3-aminopropyltrimethoxysilane (SILQUEST A-1110), 3-aminopropyltriethoxysi-lane (SILQUEST A-1100), 3-(2-aminoethyl)aminopropyltrimethoxysilane (SILQUEST A-1120), SILQUEST A-1130, (aminoethylaminomethyl)phenethyltrime-thoxysilane, (aminoethylaminomethyl)phenethyltriethoxysilane, N-(2-aminoethyl)-3-aminopropylmethyldimethoxysilane (SILQUEST A-2120), bis-(.gamma.-triethoxysilylpropyl) amine (SILQUEST A-1170), N-(2-aminoethyl)-3-aminopropyltributoxysilane, 6-(aminohexylaminopropyl)t-rimethoxysilane, 4-aminobutyltrimethoxysilane, 4-aminobutyltriethoxysilane-, p-(2-aminoethyl)phenyltrimethoxysilane, 3-aminopropyltris(methoxyethoxye-thoxy)silane, 3-aminopropylmethyldiethoxysilane, oligomeric aminosilanes such as DYNASYLAN 1146, 3-(N-methylamino)propyltrimethoxysilane, N-(2-aminoethyl)-3-aminopropylmethyldimethoxysilane, N-(2-aminoethyl)-3-aminopropylmethyldiethoxysilane, N-(2-aminoethyl)-3-aminopropyltrimethoxysilane, N-(2-aminoethyl)-3-aminopropyltriethoxysilane, 3-aminopropylmethyldiethoxysilane, 3-aminopropylmethyldimethoxysilane, 3-aminopropyldimethylmethoxysilane, 3-aminopropyldimethylethoxysilane.

Alkoxy silane adhesion promoting groups are surmised to provide improved adhesive to siliceous surfaces such as glass.

In some embodiments, the functionalization compound is an ethylenically unsaturated compound comprising at least one hydroxy-reactive group such as epoxy, and an ethylenically unsaturated group such as (meth)acrylate, (meth)acrylamide, and vinyl. Suitable functionalization compounds include for example glycidyl (meth)acrylate.

Ethylenically unsaturated adhesion promoting groups are surmised to provide improved adhesive to ethylenically unsaturated polymerizable resin compositions.

Polymeric substrates may be prepared from the functionalized polyurethane polymer described herein. Such substrates may be of any shape, form, or size (e.g. film, sheet, shaped article). The functionalized polyurethane polymer is typically thermoplastic. Polymeric films may be prepared by known techniques including casting or melt extrusion.

The functionalized polyurethane polymer is also suitable for use as a primer for various substrates.

In some embodiments, a primer layer is provided by dissolving the functionalized polyurethane polymer in an aqueous or organic solvent (e.g. propylene glycol ether acetate), coating the solution onto a substrate, and drying the coating to evaporate the aqueous or organic solvent.

The thickness of the dried primer layer is typically at least 100, 150, 200, 250, or 300 nm and no greater than 600, 700, 800, 900, or 1000 nm. However, when the functionalized polyurethane polymer is utilized for other purposes the thickness may range up to 1, 2, 3, 4, or 5 mils (1250 microns) or greater.

The substrate may include an inorganic substrate, such as a metal or an inorganic glass, or an organic substrate, such as a fluoropolymer or a non-fluorinated polymer. Alternatively, the substrate may be an organic-inorganic composite. The metal may be copper or stainless steel. The inorganic glass may be a silicate. The non-fluorinated polymer may be a polyamide, a polyolefin, a polyurethane, a polyester, a polyimide, a polyimide, a polystyrene, a polycarbonate, a polyketone, a polyurea, a polyacrylate, and a polymethylmethacrylate, or a mixture thereof. For example, the non-fluorinated polymer may be a non-fluorinated elastomer, such as acrylonitrile butadiene (NBR), butadiene rubber, chlorinated and chlorosulfonated polyethylene, chloroprene, ethylene-propylene monomer (EPM) rubber, ethylene-propylene-diene monomer (EPDM) rubber, epichlorohydrin (ECO) rubber, polyisobutylene, polyisoprene, polysulfide, polyurethane, silicone rubber, blends of polyvinyl chloride and NBR, styrene butadiene (SBR) rubber, ethylene-acrylate copolymer rubber, and ethylene-vinyl acetate rubber. Suitable ethylene-vinyl acetate copolymers include ELVAX′ available from E.I DuPont de Nemours Co., Wilmington, Del.

In some embodiments, the substrate comprises or consists of a fluoropolymer. Fluoropolymers are general derived from one or more fluorinated monomer(s) such as tetrafluoroethylene (TFE), vinyl fluoride (VF), vinylidene fluoride (VDF), hexafluoropropylene (HFP), pentafluoropropylene, trifluoroethylene, trifluorochloroethylene (CTFE), perfluorovinyl ethers (including perfluoroallyl vinyl ethers and perfluoroalkoxy vinyl ethers), perfluoroallyl ethers (including perfluoroalkyl allyl ethers and perfluoroalkoxy allyl ethers), perfluoroalkyl vinyl monomers, and combinations thereof.

In some embodiments, the fluoropolymer is formed from the constituent monomers known as tetrafluoroethylene (“TFE”), hexafluoropropylene (“HFP”), and vinylidene fluoride (“VDF,” “VF2,”). The monomer structures for these constituents are shown below:

TFE: CF₂=CF₂ (1)

VDF: CH₂=CF₂ (2)

HFP: CF₂=CF—CF₃ (3)

The fluoropolymers preferably comprise at least two of the constituent monomers (HFP and VDF), and more preferably all three of the constituents monomers in varying molar amounts. Additional monomers not depicted in (1), (2) or (3) but also useful include perfluorovinyl ether monomers of the general structure CF₂=CF—OR_{f}, wherein R_{f} can be a branched or linear perfluoroalkyl radicals of 1-8 carbons and can itself contain additional heteroatoms such as oxygen. Specific examples are perfluoromethyl vinyl ether, perfluoropropyl vinyl ethers, perfluoro(3-methoxy-propyl) vinyl ether. Additional examples are found in Worm (WO 00/12574), assigned to 3M, and in Carlson (U.S. Pat. No. 5,214,100).

Various fluoroplastics and fluoroelastomers are known such as described in U.S. Pat. No. 3,929,934. In some embodiments, the elastomers have the general formula:

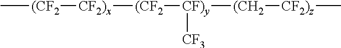

wherein x, y and z are expressed as molar percentages. In some embodiments, x, y, and z are chosen such that the elastomer comprises no greater than 40 or 35 wt.-% TFE, no greater than 25 wt. % HFP and no greater than 70, 65, or 60 wt.-% VDF. In other embodiments, the fluoroelastomer may be a copolymer comprising no more than 80, 70 or 60 wt.-% VDF and no more than 60, 50, or 40 wt.-% HFP.

For improved durability, the fluoropolymer may be polymerized in the presence of a chain transfer agent and/or halogen-containing cure site monomers and/or halogenated endgroups to introduce cure sites into the fluoropolymer. These halogen groups can provide reactivity with the adhesion promoting group and facilitate the formation of the polymer network. Useful halogen-containing monomers are well known in the art and typical examples are found in WO2014/179432.

Optionally halogen cure sites can be introduced into the polymer structure via the use of halogenated chain transfer agents which produce fluoropolymer chain ends that contain reactive halogen endgroups. Such chain transfer agents (“CTA”) are well known in the literature and typical examples are: Br—CF₂CF₂—Br, CF₂Br₂, CF₂I₂, CH₂I₂. Other typical examples are found in U.S. Pat. No. 4,000,356 to Weisgerber.

In another embodiment, the fluoropolymer can be rendered reactive by dehydrofluorinated by any method that will provide sufficient carbon-carbon unsaturation of the fluoropolymer to create increased bond strength between the fluoropolymer and a hydrocarbon substrate or layer. The dehydrofluorination process is a well-known process to induced unsaturation and it is used most commonly for the ionic crosslinking of fluoroelastomers by nucleophiles such as diphenols and diamines. This reaction is characteristic of VDF containing elastomers. Furthermore, such a reaction is also possible with primary and secondary aliphatic monofunctional amines and will produce a DHF-fluoropolymer with a pendent amine side group.

### EXAMPLES

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

| Material | Obtained from |
|---|---|
| KURARAY POLYOL P-1020 | Kuraray America, Inc., Houston, TX under trade |
| | designation “KURARAY POLYOL P-1020” |
| Dicyclohexylmethane-4,4′- | Bayer Maerials Science, Pittsburgh, PA |
| diisocyanate | |
| Dibutyltin dilaurate | Sigma-Aldrich Chemical Company, St. Louis, MO |
| Propylene glycol methyl ether | TCI America, Portland, OR |
| acetate | |
| 2,6-Bis(hydroxymethy1)-p-cresol | Sigma-Aldrich Chemical Company, St. Louis, MO |
| Ethanol | Kuraray America, Inc., Houston, TX |
| CX100 | DSM NeoResins, Inc. Augusta, GA, under trade |
| | designation “CX100” |
| Tetra-n-butylphosphonium | Alfa-Aesar, Ward Hill, MA |
| hydroxide | |
| 1-Methoxy-2-propanol | Alfa-Aesar, Ward Hill, MA |
| 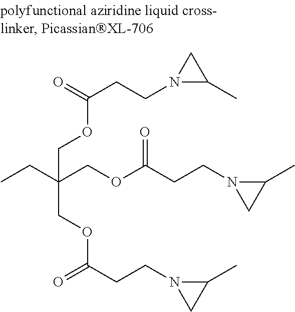 [SMILES: CCC(COC(=O)CCN1CC1C)(COC(=O)CCN1CC1C)COC(=O)CCN1CC1C] | Stahl Holdings b.v. Sluisweg 10, 5145 AP Waalwijk, The Netherlands. |

### Example 1

### Preparation of Diisocyanate Terminated Prepolymer and Phenolic Polyurethane (PU)

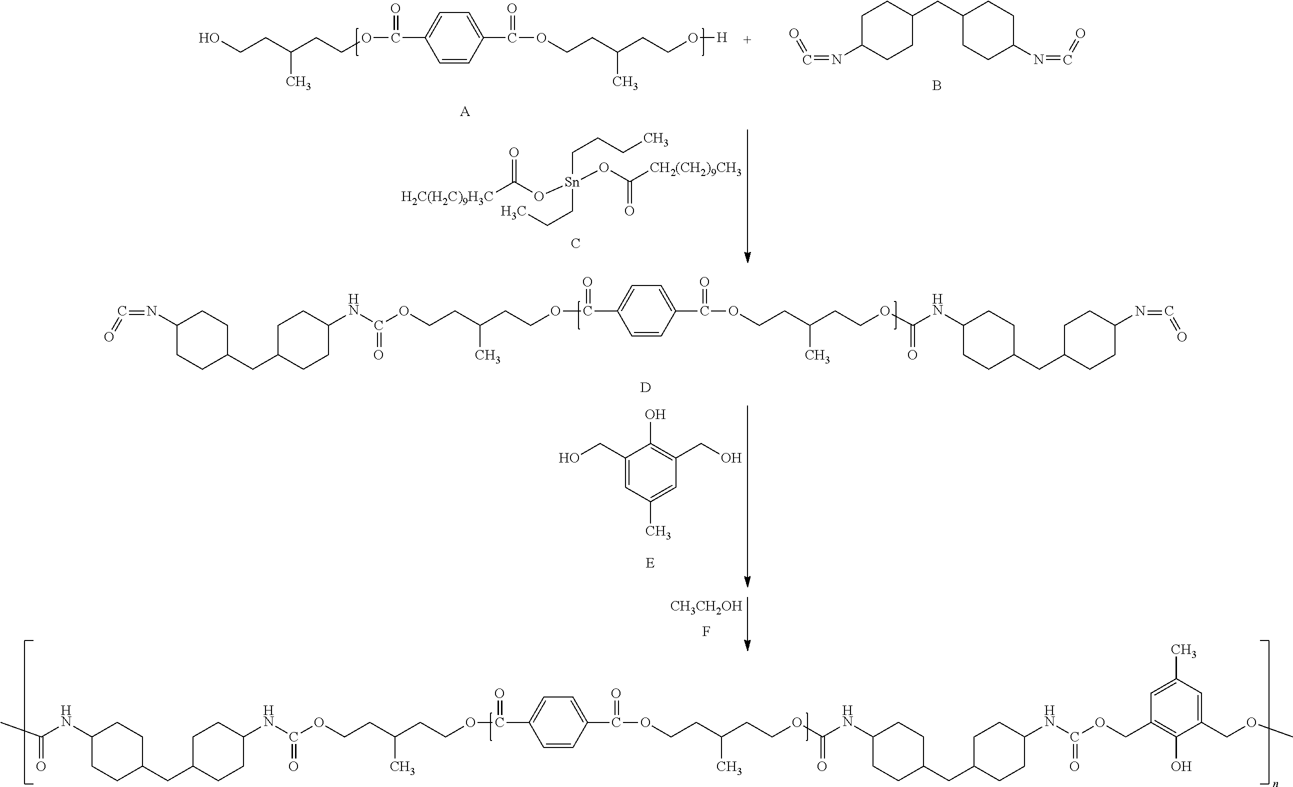

| | | MW | Amount | | |
|---|---|---|---|---|---|
| Compound | | (g/mol) | (g) | Mol | Eq |
| KURARAY POLYOL | A | 1000 | 20 | 0.02 | 1 |
| P-1020 | | | | | |
| Dicyclohexylmethane- | B | 262.352 | 10.494 | 0.04 | 2 |
| 4,4′-diisocyanate | | | | | |
| Dibutyltin dilaurate | C | 631.56 | 0.1532 | 0.2426E−3 | — |
| Diisocyanate termin- | D | — | — | — | — |
| ated pre-polymer | | | | | |
| Propylene glycol | PMA | 132.16 | 71.15 | — | — |
| methyl ether acetate | | | | | |
| 2,6-Bis(hydroxy- | E | 168.19 | 3.0274 | 0.018 | 0.9 |
| methyl)-p-cresol | | | | | |
| Ethanol | F | 46.07 | 2 | — | — |

In a vial, A, B, and C were dissolved in propylene glycol methyl ether acetate (PMA) and placed in the 80° C. oven for 2 hrs. The resulting solution, diisocyanate terminated pre-polymer (D), was allowed to cool down to room temperature and E was added into the mixture. The mixture was stirred with magnetic stir bar at room temperature for 3 hrs and F was added into the viscous polymer liquid to quench the isocyanate end groups. The reaction of isocyanate end group with ethanol was confirmed by FT-IR. A peak of isocyanate group at 2270 cm⁻¹ was completely disappeared after adding ethanol. Viscous yellowish liquid was produced. The solution was used for post-functionalization.

The resulting polyurethane intermediate contained 60 wt-% of polymerized polyester polymer units, 31 wt-% of polymerized isocyanate units, and 9 wt-% hydroxy functional aromatic units.

### Examples 2-1 to 2-2

### Post-Functionalization of Phenolic PU

### Example 2-1

| | | MW | Amount | | |
|---|---|---|---|---|---|
| Compound | | (g/mol) | (g) | Mol | Eq |
| Phenolic Polyurethane | A | — | 0.584 | — | |
| (30 wt % in PMA soln.) | | | | | |
| Tetra-n-butylphosphonium | B | 276.44 | 0.1855 g | 0.0002685 | |
| hydroxide (40% w/w aq, | | | | | |
| soln.) | | | | | |
| 1-methoxy-2-propanol | MPA | 90.12 | 4.75 | — | |

A was dissolved in MPA (1-methoxy-2-propanol). Then, B was added into the 5 wt. % solution. Transparent yellowish solution was produced. The resulting polyurethane polymer contained 30 wt-% of adhesion promoting (e.g. tetra-n-butylphosphonium) groups.

### Example 2-2

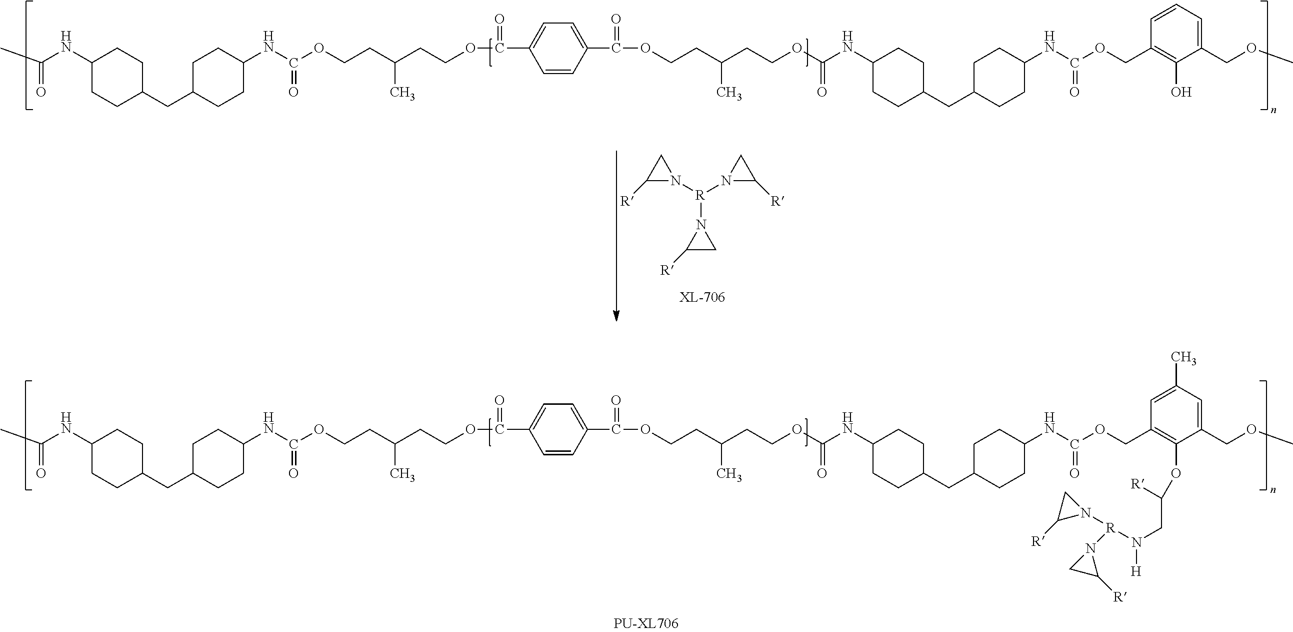

| | | MW | Amount | | |
|---|---|---|---|---|---|
| Compound | | (g/mol) | (g) | Mol | Eq |
| Phenolic Polyurethane | A | — | 0.584 | — | |
| (30 wt % in PMA soln) | | | | | |
| XL-706 | B | 467.60 | 0.126 | 0.0002685 | |
| 1-Methoxy-2-propanol | MPA | 90.12 | 4.75 | — | |

A was dissolved in MPA (1-methoxy-2-propanol). Then, B was added into the solution. Transparent yellowish solution was produced.

The resulting polyurethane polymer contained 42 wt-% of adhesion promoting (e.g. tetra-n-butylphosphonium) groups.

Since the moles of the hydroxy functional aromatic group of the polyurethane intermediate far exceed the moles of adhesion promoting compound, most all the adhesion promoting compound is bonded to the polyurethane polymer.

### Examples 3 to 10

To prepare Examples 3 to 10, the polymer solutions prepared in Examples 2-1 and 2-2 above were coated using a #4 Meyer bar onto a PET film (without any primers) and dried in a 120° C. oven for 15 min. The coated films showed excellent adhesion to PET substrates. Then, the coated PET films were laminated with THV 612 (obtained from 3M Company, St. Paul, Minn., under trade designation “3M DYNEON FLUOROPLASTIC THV 612”) at 190° C. and 40 psi (0.276 MPa) by using an impulse heat sealer obtained from Sencorp Systems Inc., Hyannis, Mass. The lamination time was varied from 1 to 10 min. Laminated Examples 3-10 samples were used for T-peel test and moisture stability test. To perform T-peel test, a strip of 0.5 inch wide and at least 1.5 inch length (1.27 cm wide and at least 3.8 cm long) of the above laminate was prepared for each Example. The PET and THV layer was placed in an opposed clamp of an INSTRON tester (Model 1122, obtained from Instron, Norwood, Mass.). Peel strength was measured at 1 inch (2.54 cm) jaw spacing and cross-head speed of 101.6 millimeters/minute. To determine the moisture stability of the Examples 3-10 samples they were aged at 65° C. and 90% RH for about 1 week, followed by performing T-peel test as described above. Table 1, below summarizes the phenolic polyurethane (PU) primer, and the lamination time used and T-peel test data with and/or without aging for Examples 3-10 samples.

TABLE 1

| | Phenolic PU | Lamination time | Peel Strength (N/cm) | |
|---|---|---|---|---|
| Example | primer | (min) | No aging | After aging |
| Example 3 | Example 2-1 | 1 | 4.5 | N/M |
| Example 4 | Example 2-1 | 3 | 4.5 | N/M |
| Example 5 | Example 2-1 | 5 | 4.0 | 4.0 |
| Example 6 | Example 2-1 | 10 | 4.0 | 4.8 |
| Example 7 | Example 2-2 | 1 | N/M | N/M |
| Example 8 | Example 2-2 | 3 | 4.0 | 4.3 |
| Example 9 | Example 2-2 | 5 | N/M | 4.3 |
| Example 10 | Example 2-2 | 10 | N/M | 4.5 |

*N/M means not measured

1. A polyurethane polymer comprising polymerized units comprising a hydroxy functional aromatic group wherein the hydroxy group has been functionalized with an adhesion promoting group.

2. The polyurethane polymer of claim 1 wherein the polyurethane polymer comprises polymerized units having the general structure 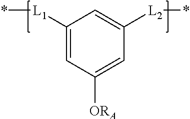
wherein L₁ and L₂ are independently divalent linking groups comprising a urethane group; and
R_{A} is an adhesion promoting group bonded to the oxygen atom by means of an ionic or covalent bond.

3. The polyurethane polymer of claim 2 wherein R_{A} is a cation of a salt of a strong base.

4. The polyurethane polymer of claim 3 wherein R_{A} is an organophosphonium cation.

5. The polyurethane polymer of claim 2 wherein R_{A} comprises a N-heterocyclic cation.

6. The polyurethane polymer of claim 2 wherein R_{A} comprises an amine.

7. The polyurethane polymer of claim 2 wherein R_{A} comprises an aziridine group.

8. The polyurethane polymer of claim 2 wherein R_{A} comprises an alkoxy silane group.

9. The polyurethane polymer of claim 2 wherein R_{A} comprises an ethylenically unsaturated group.

10. The polyurethane polymer of claim 9 wherein R_{A} comprises a (meth)acrylic group.

11. The polyurethane polymer of claim 1 further comprising polymerized unit of a polymeric polyol.

12. The polyurethane polymer of claim 11 wherein the polymeric polyol is a polyester polyol, a polycarbonate polyol, a polyether polyol, or a combination thereof.

13. A polyurethane film comprising the polyurethane polymer of claim 1.

14. A film comprising a primer layer, the primer layer comprising the polyurethane polymer of claim 1.

15. A laminate comprising the film of claim 14 wherein the primer layer is bonded to a fluorine-containing polymer film.

16. The laminate of claim 15 wherein the fluorine-containing polymer film is a fluoropolymer comprising polymerized units selected from tetrafluoroethylene, vinylidene fluoride and hexafluoropropylene.

17. A method of making a polyurethane polymer comprising
providing a polyurethane polymer intermediate comprising polymerized units of a hydroxy-functional aromatic group;
reacting the hydroxy-functional aromatic group with a functionalization compound having the formula R_{OH}—R_{A},
wherein R_{OH} is an hydroxy-reactive group and R_{A} is an adhesion-promoting group.

18. (canceled)

19. The method of claim 17 wherein the polyurethane polymer intermediate is prepared by reacting
at least one polymeric polyol;
at least one diisocyanate; and
at least one aromatic polyol comprising at least three hydroxy groups.

20. The method of claim 19 wherein the at least one aromatic polyol comprising at least three hydroxy groups is a triol, a hydroxy-functional ester diol, or a hydroxy-functional amide diol.
